(19) United States
(12) Patent Application Publication
(10) Pub. No.: US 2018/0365581 A1
(43) Pub. Date: Dec. 20, 2018

(54) RESOURCE-AWARE CALL QUALITY EVALUATION AND PREDICTION

(71) Applicant: Cisco Technology, Inc., San Jose, CA (US)

(72) Inventors: Jean-Philippe Vasseur, Saint Martin D'uriage (FR); Grégory Mermoud, Veyras (CH); Pierre-André Savalle, Rueil-Malmaison (FR); Javier Cruz Mota, Assens (CH)

(21) Appl. No.: 15/704,595

(22) Filed: Sep. 14, 2017

Related U.S. Application Data
(60) Provisional application No. 62/522,378, filed on Jun. 20, 2017.

(51) Int. Cl. G06N 7/00; H04L 12/24; G06N 99/00

(52) U.S. Cl. CPC G06N 7/005; H04L 65/403; G06N 99/005; H04L 41/5038

(57) ABSTRACT

In one embodiment, a service uses a set of collected characteristics of a client device in a network as input to a machine learning-based model that predicts a quality score for an online conference in which the client device is a participant. The service determines a resource consumption by the client device or the network that is associated with collecting the characteristics of the client device. The service determines an efficacy of the machine learning-based model as a function of the set of collected characteristics of the client device. The service adjusts the set of collected characteristics of the client device to optimize the efficacy of the model and the resource consumption associated with collecting the characteristics of the client device.

### RELATED APPLICATION

This application claims priority to U.S. Provisional Patent Appl. No. 62/522,378, filed on Jun. 20, 2017, entitled RESOURCE-AWARE CALL QUALITY EVALUATION AND PREDICTION, by Vasseur, et al., the contents of which are incorporated herein by reference.

### TECHNICAL FIELD

The present disclosure relates generally to computer networks, and, more particularly, to resource-aware call quality evaluation and prediction.

### BACKGROUND

Various forms of online conferencing options now exist in a communication network. In some cases, an online conference may be an audio conference using, e.g., Voice over Internet Protocol (VoIP) or the like. In other cases, an online conference may be a video conference in which one or more participants of the conference stream video data to the other participants (e.g., to allow the other participants to see the presenter, to allow the sharing of documents, etc.). Typically, video conferencing of this sort also supports audio streaming.

In general, network traffic for an online conference is more sensitive to networking problems than other forms of traffic. For example, a slight delay of a few seconds in loading a webpage may be almost unperceivable to a user. In contrast, a delay of only a fraction of a second in an audio stream may still be perceivable to a user.

To ensure a minimum threshold of network performance, one mechanism is the enactment of a Service Level Agreement (SLA) that can be applied to sensitive traffic such as conferencing traffic, industrial traffic, etc. Accordingly, various control plane mechanism have been developed such as Resource Reservation Protocol (RSVP) signaling, Video/Voice Call Admission Control (CAC), Multi-Topology Routing (MTR), Traffic Engineering (TE) mechanism, Quality of Service (QoS) mechanisms (e.g., traffic marking, shaping, queueing, etc.), and the like.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates an example network assurance system;

FIG. 4 illustrates an example architecture for resource-aware call quality evaluation and prediction;

FIG. 5 illustrates example test results of the importance of certain features over others when evaluation and predicting call quality; and

FIG. 6 illustrates an example simplified procedure for adaptively adjusting client characteristic collection for quality prediction.

### DESCRIPTION OF EXAMPLE EMBODIMENTS

### Overview

According to one or more embodiments of the disclosure, a service uses a set of collected characteristics of a client device in a network as input to a machine learning-based model that predicts a quality score for an online conference in which the client device is a participant. The service determines a resource consumption by the client device or the network that is associated with collecting the characteristics of the client device. The service determines an efficacy of the machine learning-based model as a function of the set of collected characteristics of the client device. The service adjusts the set of collected characteristics of the client device to optimize the efficacy of the model and the resource consumption associated with collecting the characteristics of the client device.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

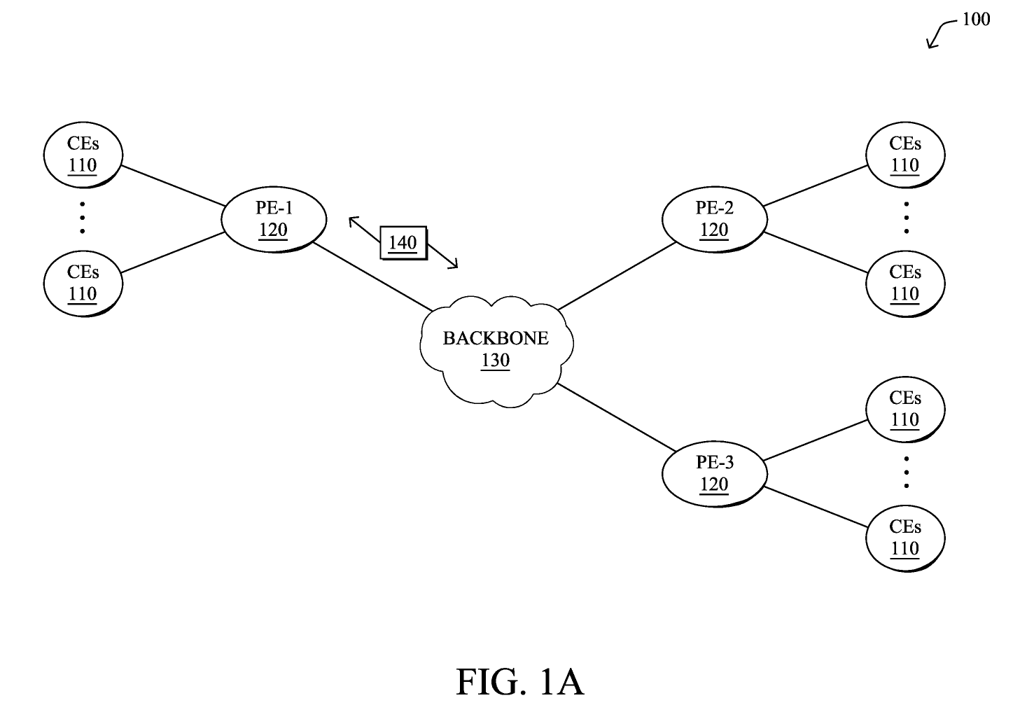

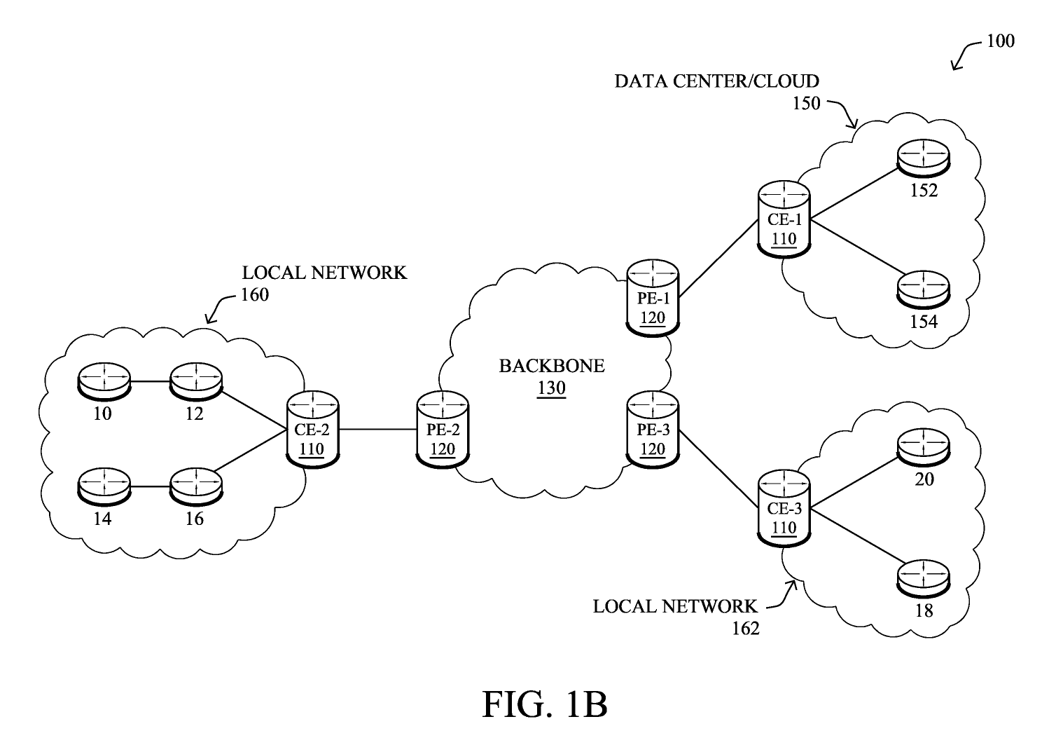

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/LTE backup connection). For example, a particular CE router 110 shown in network 100 may support a given customer site, potentially also with a backup link, such as a wireless connection.

2.) Site Type B: a site connected to the network using two MPLS VPN links (e.g., from different Service Providers), with potentially a backup link (e.g., a 3G/4G/LTE connection). A site of type B may itself be of different types:

2a.) Site Type B1: a site connected to the network using two MPLS VPN links (e.g., from different Service Providers), with potentially a backup link (e.g., a 3G/4G/LTE connection).

2b.) Site Type B2: a site connected to the network using one MPLS VPN link and one link connected to the public Internet, with potentially a backup link (e.g., a 3G/4G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

In various embodiments, network 100 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often on what is referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 160 may be an LLN in which CE-2 operates as a root node for nodes/devices 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QoS), security, network management, and traffic engineering extremely challenging, to mention a few.

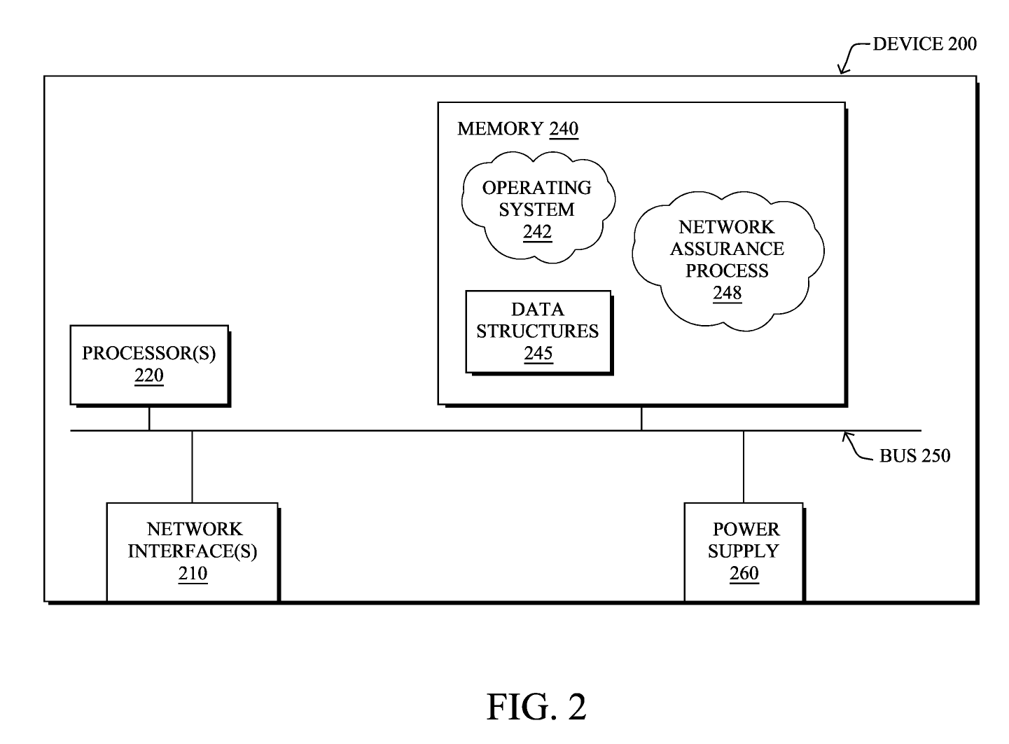

FIG. 2 is a schematic block diagram of an example node/device 200 that may be used with one or more embodiments described herein, e.g., as any of the computing devices shown in FIGS. 1A-1B, particularly the PE routers 120, CE routers 110, nodes/device 10-20, servers 152-154 (e.g., a network controller located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a network assurance process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

Network assurance process 248 includes computer executable instructions that, when executed by processor(s) 220, cause device 200 to perform network assurance functions as part of a network assurance infrastructure within the network. In general, network assurance refers to the branch of networking concerned with ensuring that the network provides an acceptable level of quality in terms of the user experience. For example, in the case of a user participating in a videoconference, the infrastructure may enforce one or more network policies regarding the videoconference traffic, as well as monitor the state of the network, to ensure that the user does not perceive potential issues in the network (e.g., the video seen by the user freezes, the audio output drops, etc.).

In some embodiments, network assurance process 248 may use any number of predefined health status rules, to enforce policies and to monitor the health of the network, in view of the observed conditions of the network. For example, one rule may be related to maintaining the service usage peak on a weekly and/or daily basis and specify that if the monitored usage variable exceeds more than 10% of the per day peak from the current week AND more than 10% of the last four weekly peaks, an insight alert should be triggered and sent to a user interface.

Another example of a health status rule may involve client transition events in a wireless network. In such cases, whenever there is a failure in any of the transition events, the wireless controller may send a reason_code to the assurance system. To evaluate a rule regarding these conditions, the network assurance system may then group 150 failures into different “buckets” (e.g., Association, Authentication, Mobility, DHCP, WebAuth, Configuration, Infra, Delete, De-Authorization) and continue to increment these counters per service set identifier (SSID), while performing averaging every five minutes and hourly. The system may also maintain a client association request count per SSID every five minutes and hourly, as well. To trigger the rule, the system may evaluate whether the error count in any bucket has exceeded 20% of the total client association request count for one hour.

In various embodiments, network assurance process 248 may also utilize machine learning techniques, to enforce policies and to monitor the health of the network. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, network assurance process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that network assurance process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

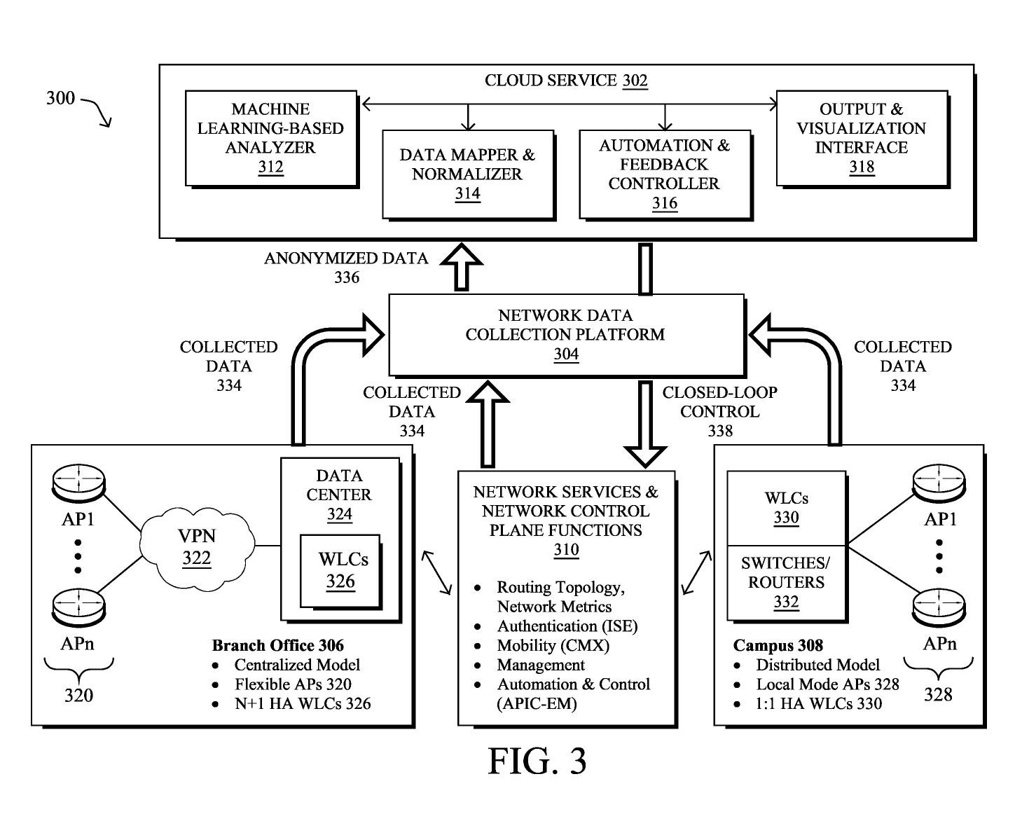

FIG. 3 illustrates an example network assurance system 300, according to various embodiments. As shown, at the core of network assurance system 300 may be a cloud service 302 that leverages machine learning in support of cognitive analytics for the network, predictive analytics (e.g., models used to predict user experience, etc.), troubleshooting with root cause analysis, and/or trending analysis for capacity planning. Generally, architecture 300 may support both wireless and wired network, as well as LLNs/IoT networks.

In various embodiments, cloud service 302 may oversee the operations of the network of an entity (e.g., a company, school, etc.) that includes any number of local networks. For example, cloud service 302 may oversee the operations of the local networks of any number of branch offices (e.g., branch office 306) and/or campuses (e.g., campus 308) that may be associated with the entity. Data collection from the various local networks/locations may be performed by a network data collection platform 304 that communicates with both cloud service 302 and the monitored network of the entity.

The network of branch office 306 may include any number of wireless access points 320 (e.g., a first access point AP1 through nth access point, APn) through which endpoint nodes may connect. Access points 320 may, in turn, be in communication with any number of wireless LAN controllers (WLCs) 326 located in a centralized datacenter 324. For example, access points 320 may communicate with WLCs 326 via a VPN 322 and network data collection platform 304 may, in turn, communicate with the devices in datacenter 324 to retrieve the corresponding network feature data from access points 320, WLCs 326, etc. In such a centralized model, access points 320 may be flexible access points and WLCs 326 may be N+1 high availability (HA) WLCs, by way of example.

Conversely, the local network of campus 308 may instead use any number of access points 328 (e.g., a first access point AP1 through nth access point APm) that provide connectivity to endpoint nodes, in a decentralized manner. Notably, instead of maintaining a centralized datacenter, access points 328 may instead be connected to distributed WLCs 330 and switches/routers 332. For example, WLCs 330 may be 1:1 HA WLCs and access points 328 may be local mode access points, in some implementations.

To support the operations of the network, there may be any number of network services and control plane functions 310. For example, functions 310 may include routing topology and network metric collection functions such as, but not limited to, routing protocol exchanges, path computations, monitoring services (e.g., NetFlow or IPFIX exporters), etc. Further examples of functions 310 may include authentication functions, such as by an Identity Services Engine (ISE) or the like, mobility functions such as by a Connected Mobile Experiences (CMX) function or the like, management functions, and/or automation and control functions such as by an APIC-Enterprise Manager (APIC-EM).

During operation, network data collection platform 304 may receive a variety of data feeds that convey collected data 334 from the devices of branch office 306 and campus 308, as well as from network services and network control plane functions 310. Example data feeds may comprise, but are not limited to, management information bases (MIBS) with Simple Network Management Protocol (SNMP)v2, JavaScript Object Notation (JSON) Files (e.g., WSA wireless, etc.), NetFlow/IPFIX records, logs reporting in order to collect rich datasets related to network control planes (e.g., Wi-Fi roaming, join and authentication, routing, QoS, PHY/MAC counters, links/node failures), traffic characteristics, and other such telemetry data regarding the monitored network. As would be appreciated, network data collection platform 304 may receive collected data 334 on a push and/or pull basis, as desired. Network data collection platform 304 may prepare and store the collected data 334 for processing by cloud service 302. In some cases, network data collection platform may also anonymize collected data 334 before providing the anonymized data 336 to cloud service 302.

In some cases, cloud service 302 may include a data mapper and normalizer 314 that receives the collected and/or anonymized data 336 from network data collection platform 304. In turn, data mapper and normalizer 314 may map and normalize the received data into a unified data model for further processing by cloud service 302. For example, data mapper and normalizer 314 may extract certain data features from data 336 for input and analysis by cloud service 302.

In various embodiments, cloud service 302 may include a machine learning-based analyzer 312 configured to analyze the mapped and normalized data from data mapper and normalizer 314. Generally, analyzer 312 may comprise a power machine learning-based engine that is able to understand the dynamics of the monitored network, as well as to predict behaviors and user experiences, thereby allowing cloud service 302 to identify and remediate potential network issues before they happen.

Machine learning-based analyzer 312 may include any number of machine learning models to perform the techniques herein, such as for cognitive analytics, predictive analysis, and/or trending analytics as follows:
Cognitive Analytics Model(s): The aim of cognitive analytics is to find behavioral patterns in complex and unstructured datasets. For the sake of illustration, analyzer 312 may be able to extract patterns of Wi-Fi roaming in the network and roaming behaviors (e.g., the “stickiness” of clients to APs 320, 328, “ping-pong” clients, the number of visited APs 320, 328, roaming triggers, etc). Analyzer 312 may characterize such patterns by the nature of the device (e.g., device type, OS) according to the place in the network, time of day, routing topology, type of AP/WLC, etc., and potentially correlated with other network metrics (e.g., application, QoS, etc.). In another example, the cognitive analytics model(s) may be configured to extract AP/WLC related patterns such as the number of clients, traffic throughput as a function of time, number of roaming processed, or the like, or even end-device related patterns (e.g., roaming patterns of iPhones, IoT Healthcare devices, etc.).
Predictive Analytics Model(s): These model(s) may be configured to predict user experiences, which is a significant paradigm shift from reactive approaches to network health. For example, in a Wi-Fi network, analyzer 312 may be configured to build predictive models for the joining/roaming time by taking into account a large plurality of parameters/observations (e.g., RF variables, time of day, number of clients, traffic load, DHCP/DNS/Radius time, AP/WLC loads, etc.). From this, analyzer 312 can detect potential network issues before they happen. Furthermore, should abnormal joining time be predicted by analyzer 312, cloud service 312 will be able to identify the major root cause of this predicted condition, thus allowing cloud service 302 to remedy the situation before it occurs. The predictive analytics model(s) of analyzer 312 may also be able to predict other metrics such as the expected throughput for a client using a specific application. In yet another example, the predictive analytics model(s) may predict the user experience for voice/video quality using network variables (e.g., a predicted user rating of 1-5 stars for a given session, etc.), as function of the network state. As would be appreciated, this approach may be far superior to traditional approaches that rely on a mean opinion score (MOS). In contrast, cloud service 302 may use the predicted user experiences from analyzer 312 to provide information to a network administrator or architect in real-time and enable closed loop control over the network by cloud service 302, accordingly. For example, cloud service 302 may signal to a particular type of endpoint node in branch office 306 or campus 308 (e.g., an iPhone, an IoT healthcare device, etc.) that better QoS will be achieved if the device switches to a different AP 320 or 328.
Trending Analytics Model(s): The trending analytics model(s) may include multivariate models that can predict future states of the network, thus separating noise from actual network trends. Such predictions can be used, for example, for purposes of capacity planning and other “what-if” scenarios.

Machine learning-based analyzer 312 may be specifically tailored for use cases in which machine learning is the only viable approach due to the high dimensionality of the dataset and patterns cannot otherwise be understood and learned. For example, finding a pattern so as to predict the actual user experience of a video call, while taking into account the nature of the application, video CODEC parameters, the states of the network (e.g., data rate, RF, etc.), the current observed load on the network, destination being reached, etc., is simply impossible using predefined rules in a rule-based system.

Unfortunately, there is no one-size-fits-all machine learning methodology that is capable of solving all, or even most, use cases. In the field of machine learning, this is referred to as the “No Free Lunch” theorem. Accordingly, analyzer 312 may rely on a set of machine learning processes that work in conjunction with one another and, when assembled, operate as a multi-layered kernel. This allows network assurance system 300 to operate in real-time and constantly learn and adapt to new network conditions and traffic characteristics. In other words, not only can system 300 compute complex patterns in highly dimensional spaces for prediction or behavioral analysis, but system 300 may constantly evolve according to the captured data/observations from the network.

Cloud service 302 may also include output and visualization interface 318 configured to provide sensory data to a network administrator or other user via one or more user interface devices (e.g., an electronic display, a keypad, a speaker, etc.). For example, interface 318 may present data indicative of the state of the monitored network, current or predicted issues in the network (e.g., the violation of a defined rule, etc.), insights or suggestions regarding a given condition or issue in the network, etc. Cloud service 302 may also receive input parameters from the user via interface 318 that control the operation of system 300 and/or the monitored network itself. For example, interface 318 may receive an instruction or other indication to adjust/retrain one of the models of analyzer 312 from interface 318 (e.g., the user deems an alert/rule violation as a false positive).

In various embodiments, cloud service 302 may further include an automation and feedback controller 316 that provides closed-loop control instructions 338 back to the various devices in the monitored network. For example, based on the predictions by analyzer 312, the evaluation of any predefined health status rules by cloud service 302, and/or input from an administrator or other user via input 318, controller 316 may instruct an endpoint client device, networking device in branch office 306 or campus 308, or a network service or control plane function 310, to adjust its operations (e.g., by signaling an endpoint to use a particular AP 320 or 328, etc.).

As noted above, a network assurance system may use collected metrics from endpoint client devices and/or the network itself, to evaluate and predict the user experience in terms of call quality. As used herein, “call quality” is used to refer to a quality metric that represents the quality of an online conference (e.g., audio and/or video) from the perspective of the user operating a client device that participates in the conference. For example, the network assurance system may obtain and assess the characteristics of the applications executed by the endpoint client devices (e.g., type of codec, memory, etc.), to predict the call quality of a video and/or voice sessions involving the endpoint client device. Typically, the more metrics available to the prediction engine, the better the prediction. However, resources available on the endpoint client device and/or within the network itself may be limited, thereby limiting the ability of the prediction engine to obtain all available metrics at any given point in time.

Resource-Aware Call Quality Evaluation and Prediction

The techniques herein allow for a machine learning-based engine to predict voice and/or video user experience/call quality based on gathered information regarding the client device (e.g., type of codec, battery level, wireless characteristics, etc.). The system monitors the overall prediction efficacy, as well as the client constraints and overall overhead, to dynamically adjust the set of client metrics to the minimum that provides the desired level of prediction efficacy.

Illustratively, the techniques described herein may be performed by hardware, software, and/or firmware, such as in accordance with the network assurance process 248, which may include computer executable instructions executed by the processor 220 (or independent processor of interfaces 210) to perform functions relating to the techniques described herein.

Specifically, a service uses a set of collected characteristics of a client device in a network as input to a machine learning-based model that predicts a quality score for an online conference in which the client device is a participant. The service determines a resource consumption by the client device or the network that is associated with collecting the characteristics of the client device. The service determines an efficacy of the machine learning-based model as a function of the set of collected characteristics of the client device. The service adjusts the set of collected characteristics of the client device to optimize the efficacy of the model and the resource consumption associated with collecting the characteristics of the client device.

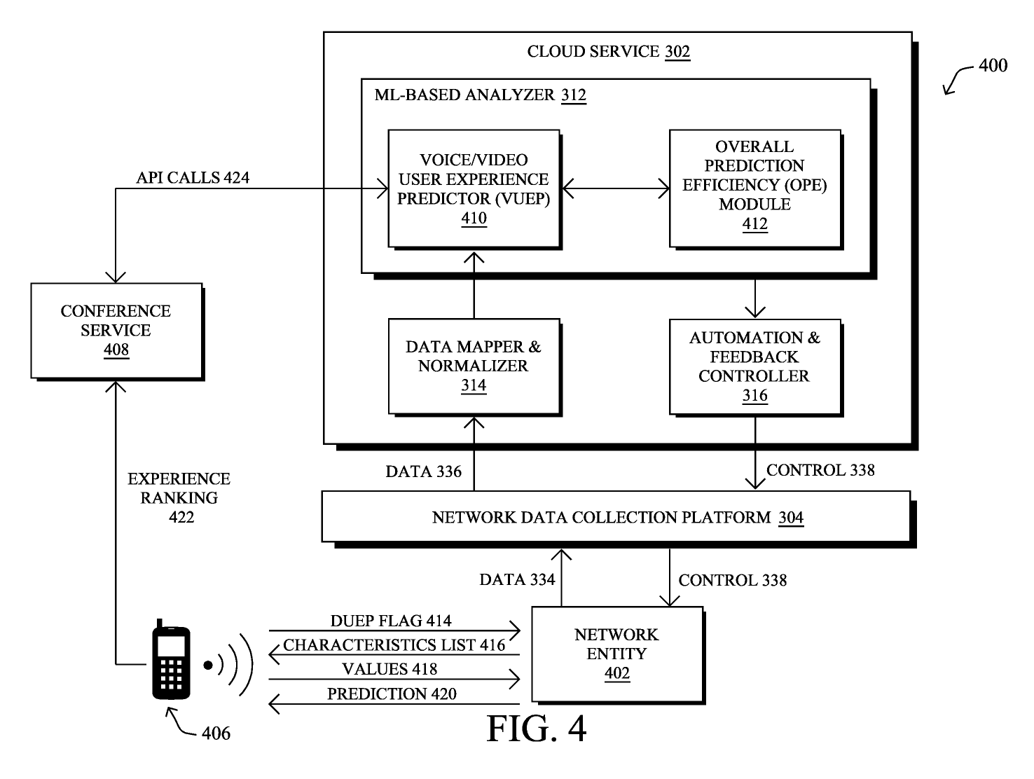

Operationally, FIG. 4 illustrates an example architecture 400 for resource-aware call quality evaluation and prediction, according to various embodiments. In various embodiments, architecture 400 shown may be implemented as part of a network assurance system, such as the assurance system illustrated in FIG. 3 and described above. Accordingly, the components of architecture 400 shown may be implemented as part of cloud service 302, as part of network data collection platform 304, and/or on network entity/data source 402 itself. These components may include, in various embodiments, a voice/video user experience predictor (VUEP) 410 and/or an overall prediction efficiency (OPE) module 412, which may be components of ML-based analyzer 312. Further, these components may be implemented in a distributed manner or implemented as its own stand-alone service, either as part of the local network under observation or as a remote service. In addition, the functionalities of the components of architecture 400 may be combined, omitted, or implemented as part of other processes, as desired.

As shown, assume that a client device 406, such as a wireless device, is in communication with a network entity 402 located in a local network, such as branch office 306 or campus 308. Notably, network entity 402 may be a wireless access point, WLC, router, switch, a combination thereof, or the like, that is configured to provide collected data 336 to network data collection platform 304 and receive control instructions 338, in response. Now, assume for purposes of illustration that client device 406 is to participate in an online conference and/or is currently participating in such a conference that is provided by conference service 408. For example, conference service 408 may be a cloud-based service or other online service that connects client device 406 with any number of other client devices for purposes of sharing audio and/or video traffic.

One aspect of the techniques herein introduces a new flag referred to as a Dynamic User Experience Prediction (DUEP) flag 414, which allows endpoint client device 406 to signal its willingness to leverage the resource-aware mechanism introduced herein. DUEP flag 414 may be conveyed, for example, via 802.11 messaging from client device 406 to the network assurance system (e.g., assurance system 300). Notably, the setting of the DUEP flag 414 by client device 406 may signal to ML-based analyzer 312 that predicted quality metrics are requested and that client device 406 is available to send characteristics of client device 406 to the network assurance system for processing.

If the DUEP flag 414 is set, and the client-AP finite state machine (FSM) is in the ‘RUN’ state, the AP (e.g., network entity 402) may send a list 416 to client device 406 of the device and/or application characteristics that are requested by the network assurance system, to start training the model of, and performing user experience predictions by, VUEP 410.

Potential client-side characteristics that VUEP 410 may collect and use for the predictions may include, but are not limited to, metrics related to audio quality (e.g., bitrate, losses, jitter, etc.), to video quality (e.g., bitrates and resolution, frames per second, frames skipped, etc.), device utilization (e.g., CPU usage, memory usage, type of device, etc.), screen or media sharing quality for applications where this is relevant, network features measured at the client (e.g., wireless metrics as seen from the endpoint client device), combinations thereof, and the like. More specifically, the following are example metrics that the network assurance system may obtain for use in making the quality evaluations and predictions:
inherentLoss,
afterFecLossRatio,
audioAvgSendingBandwidth,
audioSenderMetricTime,
delayEvent,
fastLaneType,
fecEnable,
fecRxBitrate,
fecTxBitrate,
jitter,
lossRatio,
mediaRxBitrate,
mediaTxBitrateoooGapLen,
oooGapLen,
rtt,
linkRate,
localFrameRate,
localIDRIntervalBitRate,
localResolutionFS,
longestContinualAvOooSeconds,
lossRatio,
etc.

The above list may include summary statistics about a variety of client-side characteristics. These can be computed during a voice or audio call, or based on previous calls from client device 406, in a similar environment.

Optionally, VUEP 410 may gather additional information related to the client by calling an application program interface (API) in a controller such as an Identity Services Engine (ISE), which can augment the client-based dataset by inspecting its database (e.g., static data, end device profiling, dynamic information provided by 802.1X, etc.). The client and application-based metrics may also be augmented with network-based metrics (e.g., CPU of the platform, RF metrics from the AP/WLC, network-based metrics, etc.) before being sent to VUEP 410. In addition, VUEP 410 may be hosted in the cloud (e.g., as part of cloud service 302) or, alternatively, on premise with network entity 402.

Additional information that VUEP 410 may obtain for purposes of training its predictive model are user experience rankings 422 that client device 406 may provide to conference service 408. Generally, rankings 422 may be subjective rankings indicated by the user of device 406 regarding the perceived quality of a video and/or audio conference facilitated by conference service 408. For example, rankings 422 may be a star ranking on a scale of 1-5 stars, a numerical ranking of 1-10, or any other form of suitable ranking. This information can then be leveraged by VUEP 410 (e.g., via API calls 424 to conference service 408), to form its predictive model that predicts quality metrics based on the characteristics of a client device, the operation of the network in which the client device is located, and/or any other information that may be an indicator of the call quality.

Using the obtained data features regarding the application, client device, network, etc., VUEP 410 may train a machine learning-based model in order to predict voice and/or video quality experienced by the endpoint client device 406. Such a model may be, for example, a regression-based model, a classifier, or the like. Considering the large quantity of features, a model with a large modeling capacity such as a Deep Neural Network (DNN) may advantageously be used.

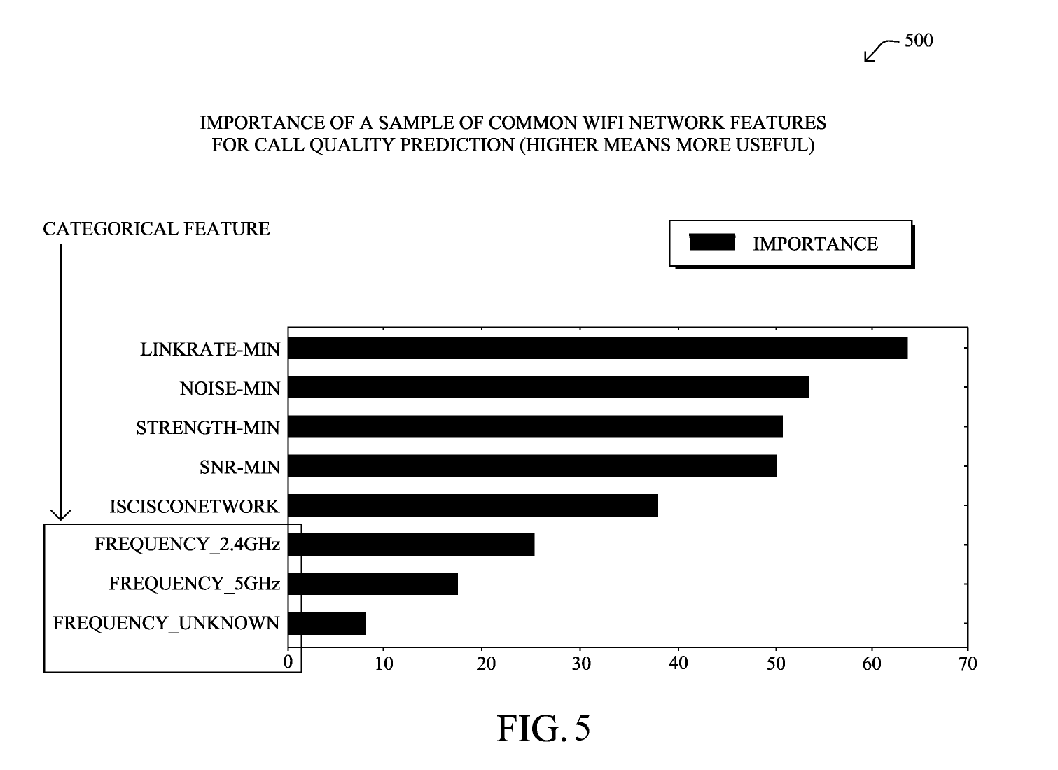

Referring briefly to FIG. 5, example test results 500 are shown of the importance of certain features over others when evaluation and predicting call quality. A prototype regression-based quality prediction model was trained using a robust set of input features that included the features shown. As shown, the various features were observed to have different degrees of importance with respect to the call quality prediction. In other words, some input features had a much stronger effect on the output prediction than other input features.

Another aspect of the techniques herein relates to the ability for the system to perform a tradeoff between the extra cost in polling client-based characteristics and the efficacy of the classifier predicting a good versus bad call, should for example a classifier be used by the VUEP 410. Indeed, energy is a scarce resource on battery-powered end device, such as client device 406, and the gathering of such data may become problematic. To that end, in some embodiments, the network assurance system may further include an Overall Prediction Efficacy (OPE) module 412 that determines the optimal set of required characteristic data from the endpoint client device 406, the objective being to find the required minimum set of characteristics in order to achieve a good enough classification efficacy. In other words, as shown from the results in FIG. 5, certain obtained metrics/input features are more important to the prediction than others. In turn, the OPE module 412 may leverage this fact to determine which metrics/input features are actually collected.

More specifically, OPE module 412 may send control instructions 338 to network entity 402 that adjust the list 416 of characteristics requested from client device 406. In turn, this controls the reported characteristic values 418 collected by network entity 402 and reported to ML-based analyzer 312 (e.g., for input to VUEP 410).

The following factors are evaluated by OPE module 412 when determining the characteristic features of client device 406 to be collected:

Bandwidth overhead usage: since the number of variables gathered by the system not only for training, but also voice/video prediction, may be significant, the APs/WLCs evaluate the percentage of bandwidth overhead on the local wireless access (percentage of throughput); a maximum percentage (or a maximum absolute value) may be configured to bound the overall overhead. Note that this overhead evaluation can be constantly adapted based on current networking conditions and/or future expected conditions.

Client resources metrics: local end device resources of device 406, such as the battery, CPU and memory usage, type of client device, etc. may also be used as an input parameter to condition the gathering of such data.

The Prediction Efficacy: VUEP 410 may also continuously measure the PE both in terms of Precision/Recall. The objective is to select a point on the Receiver Operating Characteristic (ROC) curve (e.g., a curve that represents the false positive rate on the X-axis and the true positive rate of the y-axis) that provides the preferred trade-off between precision and recall.

In various embodiments, the objective of OPE module 412 is to determine the influence of the set of client characteristics on the prediction efficacy, while trying to minimize the overall bandwidth overhead usage under client-based constraints. For example, OPE module 412 may stop the gathering of the client-based data/characteristics if the battery level of client device 406 is below some threshold, stop gathering the client-based data if the overhead on network bandwidth exceeds X % (e.g., to report the characteristics), start gathering certain client-based data if network bandwidth usage is less than X %, etc.).

In one embodiment, OPE module 412 can optimally control the collection of characteristics of client device 406 by using a static utility function that combines the different criteria into a single overall criterion that the system can optimize. In another embodiment, OPE module 412 can adopt a more principled multi-criterion optimization strategy, possibly with interaction with system administrators, where dominating and dominated operating points are systematically determined (e.g., via a Pareto frontier).

Another aspect of the techniques herein is used not only to evaluate the prediction efficacy, but also to potentially trigger a fast retraining of VUEP 410. Once a quality prediction 420 is provided to endpoint client device 406, a custom control plane message may be sent to device 406 using a new type-length-value (TLV) carried in the 802.11k/v signaling, so as to explicitly request a feed-back on the predicted (voice/video) call. Such a feedback may be ‘IGNORE’ (e.g., device 406 does not take into account the prediction), ‘ROAM’ (e.g., device 406 decides to roam to another AP) or ‘REROUTE’ (e.g., client 406 reroutes the voice/video call onto another media/network, such as 4G). A second TLV may also be used to optionally provide the label for the voice/video call quality feedback (that TLV may be ignored if provided via other means such as the application itself).

The TLVs proposed above may also be propagated back to VUEP 410 and used to assess the efficacy of the prediction (e.g., to determine whether the prediction was correct). The machine learning process may also give more weight to a voice/video calls sample that has been roamed or rerouted. An incorrect prediction after a ‘ROAM,’ for example, may trigger an increase of the weights for the corresponding samples. Said differently, such a mechanism can be seen as a form of active learning for the system where more weight is given to calls incorrectly predicted. In another embodiment, the fast retraining can also be triggered by changes in the network and/or the client device that lead to a change in the evaluation of the bandwidth overhead usage or the client resources metrics.

Furthermore, OPE module 412 may decide to increase/reduce the frequency of training given the performance of the prediction efficacy, if permitted (e.g., based on overall bandwidth overhead, etc.). For example, when the overall efficacy of the system becomes satisfactory, the frequency at which client-side data are gathered and provided to VUEP 410 for constant training may be reduced (thanks to a notification signal sent to all AP/WLC).

VUEP 410 may enhance its models in order to take into account the type of applications of course but also the type of client, either by using different model or adding the relevant input features in the model (e.g., data gather in-band or out-of-band thanks to a controller such as ISE, as discussed above).

In yet another embodiment, the detection of a new application (e.g., a new CODEC type on a voice application), or a new type of device by VUEP 410 may increase both the number of client based metrics gathered and the frequency at which data is collected until the prediction efficacy stabilizes to a satisfactory level, using active learning.

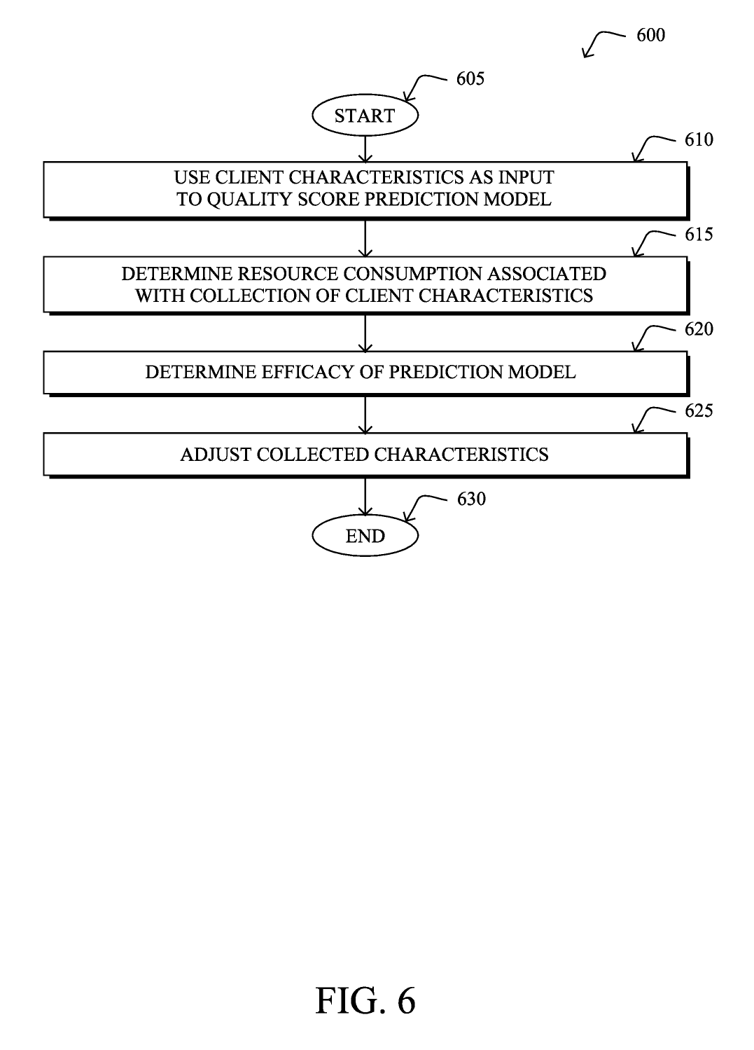

FIG. 6 illustrates an example simplified procedure for adaptively adjusting client characteristic collection for quality prediction, in accordance with one or more embodiments described herein. For example, a non-generic, specifically configured device (e.g., device 200) may perform procedure 600 by executing stored instructions (e.g., process 248), to implement a network assurance service. The procedure 600 may start at step 605 and continue on to step 610 where, as described in greater detail above, the service may use a set of collected characteristics of a client device in a network as input to a machine learning-based model that predicts a quality score for an online conference in which the client device is a participant. In some cases, the model may also take into account additional factors, as well, such as user experience feedback provided by the client device to the conferencing service and obtained by the network assurance service.

At step 615, as detailed above, the service may determine a resource consumption by the client device or the network that is associated with collecting the characteristics of the client device. For example, in the case of the network, reporting the characteristics of the client device may increase the bandwidth overhead on the network and/or a particular network entity (e.g., AP, WLC, etc.) in the network. Similarly, in the case of the client device itself, the system may determine one or more resource consumption metrics that are associated with reporting the characteristics to the service and are indicative of a memory consumption by the client device, a processor consumption by the client device, a battery consumption by the client device, or a device type of the client device.

At step 620, the service may determine an efficacy of the machine learning-based model as a function of the set of collected characteristics of the client device, as described in greater detail above. For example, in some cases, the system may determine the precision and recall of its machine learning-based prediction model as they relate to the various characteristics. Notably, certain collected client characteristics may have more of an effect on the efficacy of the predictive model than others.

At step 625, as detailed above, the service may adjust the set of collected characteristics of the client device to optimize the efficacy of the model and the resource consumption associated with collecting the characteristics of the client device. In particular, the service may control which characteristics of the client device are collected and/or the collection frequency, based on how influential the characteristics are on the overall efficacy of the model. For example, the wireless frequency used by the client device may be far less influential on the efficacy of the model than the minimum link rate of the model. Thus, to reduce resource consumption as part of the collection process, the service may send an instruction that client device or to a network element, to prevent or stop collection of this characteristic. Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, dramatically improve the efficacy of user experience/call quality predictions, while limiting the overhead impact on the endpoint client device itself.

While there have been shown and described illustrative embodiments that provide for resource-aware call quality evaluation and prediction, it is to be understood that various other adaptations and modifications may be made within the spirit and scope of the embodiments herein. For example, while certain embodiments are described herein with respect to using certain models for purposes of performance modeling and/or network analysis, the models are not limited as such and may be used for other functions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
using, by a service, a set of collected characteristics of a client device in a network as input to a machine learning-based model that predicts a quality score for an online conference in which the client device is a participant;
determining, by the service, a resource consumption by the client device or the network that is associated with collecting the characteristics of the client device;
determining, by the service, an efficacy of the machine learning-based model as a function of the set of collected characteristics of the client device; and
adjusting, by the service, the set of collected characteristics of the client device to optimize the efficacy of the model and the resource consumption associated with collecting the characteristics of the client device.

2. The method as in claim 1, wherein adjusting the set of collected characteristics of the client device comprises:
selecting, by the service, a subset of the collected characteristics that optimizes the efficacy of the model and the resource consumption; and
sending, by the service, an instruction to the client device or to one or more network entities to stop collecting one or more of the characteristics based on the selected subset.

3. The method as in claim 1, wherein determining the resource consumption comprises:
determining, by the service, the resource consumption by the network associated with collecting the characteristics of the client device, wherein the resource consumption comprises a bandwidth overhead.

4. The method as in claim 1, wherein determining the resource consumption comprises:
determining, by the service, one or more resource consumption metrics for the client device associated with collecting the characteristics of the client device from the client device, wherein the resource consumption metric is indicative of at least one of: a memory consumption, a processor consumption, a battery consumption, or a device type.

5. The method as in claim 1, further comprising:
sending, by the service, an indication of the predicted quality score for the online conference to the client device; and
retraining, by the service, the machine learning-based model using feedback from the client device regarding an action taken by the client device based on the sent indication.

6. The method as in claim 5, wherein the action taken by the client device comprises one of: ignoring the predicted quality score, roaming to a different wireless access point in the network, or rerouting traffic associated with the online conference through another network, and wherein one or more samples used to retrain the model are weighted based on the action.

7. The method as in claim 5, wherein retraining the model comprises:
adjusting, by the service, a retraining frequency for the machine learning-based model based on the efficacy of the machine learning-based model.

8. The method as in claim 1, wherein determining the efficacy of the machine learning-based model comprises:
determining precision and recall of the model as a function of the set of collected characteristics of the client device.

9. The method as in claim 1, further comprising:
receiving, at the service, a request from the client device for a predicted quality score for the online conference; and
sending, by the service, the predicted quality score to the client device.

10. The method as in claim 1, further comprising:
training, by the service, the machine learning-based model in part based on a user experience score obtained from service that provides the online conference.

11. An apparatus, comprising:
one or more network interfaces to communicate with a network;
a processor coupled to the network interfaces and configured to execute one or more processes; and
a memory configured to store a process executable by the processor, the process when executed configured to:
use a set of collected characteristics of a client device in a network as input to a machine learning-based model that predicts a quality score for an online conference in which the client device is a participant;
determine a resource consumption by the client device or the network that is associated with collecting the characteristics of the client device;
determine an efficacy of the machine learning-based model as a function of the set of collected characteristics of the client device; and
adjust the set of collected characteristics of the client device to optimize the efficacy of the model and the resource consumption associated with collecting the characteristics of the client device.

12. The apparatus as in claim 11, wherein the apparatus adjusts the set of collected characteristics of the client device by:
selecting a subset of the collected characteristics that optimizes the efficacy of the model and the resource consumption; and
sending an instruction to the client device or to one or more network entities to stop collecting one or more of the characteristics based on the selected subset.

13. The apparatus as in claim 11, wherein the apparatus determines the resource consumption by:
determining the resource consumption by the network associated with collecting the characteristics of the client device, wherein the resource consumption comprises a bandwidth overhead.

14. The apparatus as in claim 11, wherein the apparatus determines the resource consumption by:
determining one or more resource consumption metrics for the client device associated with collecting the characteristics of the client device from the client device, wherein the resource consumption metric is indicative of at least one of: a memory consumption, a processor consumption, a battery consumption, or a device type.

15. The apparatus as in claim 11, wherein the process when executed is further configured to:
send an indication of the predicted quality score for the online conference to the client device; and
retrain the machine learning-based model using feedback from the client device regarding an action taken by the client device based on the sent indication.

16. The apparatus as in claim 15, wherein the action taken by the client device comprises one of: ignoring the predicted quality score, roaming to a different wireless access point in the network, or rerouting traffic associated with the online conference through another network, and wherein one or more samples used to retrain the model are weighted based on the action.

17. The apparatus as in claim 11, wherein the apparatus determines the efficacy of the machine learning-based model by:
determining precision and recall of the model as a function of the set of collected characteristics of the client device.

18. The apparatus as in claim 11, wherein the process when executed is further configured to:
receive a request from the client device for a predicted quality score for the online conference; and
send the predicted quality score to the client device.

19. The apparatus as in claim 11, wherein the process when executed is further configured to:
train the machine learning-based model in part based on a user experience score obtained from service that provides the online conference.

20. A tangible, non-transitory, computer-readable medium storing program instructions that cause a service to perform a process comprising:
using, by a service, a set of collected characteristics of a client device in a network as input to a machine learning-based model that predicts a quality score for an online conference in which the client device is a participant;
determining, by the service, a resource consumption by the client device or the network that is associated with collecting the characteristics of the client device;
determining, by the service, an efficacy of the machine learning-based model as a function of the set of collected characteristics of the client device; and
adjusting, by the service, the set of collected characteristics of the client device to optimize the efficacy of the model and the resource consumption associated with collecting the characteristics of the client device.
